(19) United States
(12) Patent Application Publication
(10) Pub. No.: US 2013/0062207 A1
(43) Pub. Date: Mar. 14, 2013

(54) METHOD AND SYSTEM FOR DISPOSAL OF BRINE SOLUTION

(71) Applicant: Rongqiang Fu, Singapore (SG)

(72) Inventor: Rongqiang Fu, Singapore (SG)

(21) Appl. No.: 13/697,689

(22) PCT Filed: May 12, 2010
(86) PCT No.: PCT/EP10/56576

§ 371 Date: Nov. 13, 2012

(51) Int. Cl. C02F 1/469

(52) U.S. Cl. CPC C02F 1/4695
USPC 204/519; 204/628

(57) ABSTRACT

A reverse electrodialyzer has a plurality of concentrated compartments and diluted compartments arranged alternatively. The concentrated compartments and the diluted compartments are formed by successive alternatively arranged oppositely charged ion exchange membranes between two electrodes. A brine solution is fed into the concentrated compartments, and a diluted solution is into the diluted compartments, the salinity of the diluted solution being lower than the salinity of the brine solution. Ions from the brine solution in the concentrated compartments pass through the membranes to the diluted solution in the diluted compartments forming a diluted brine solution in the concentrated compartments. The brine solution is extracted from the concentrated compartments for disposal. An electrical energy is produced due to the concentration difference of the brine solution and the diluted solution.

### CROSS REFERENCE TO RELATED APPLICATIONS

This application is based on and hereby claims priority to International Application No. PCT/EP2010/056576 filed on May 12, 2010, the contents of which are hereby incorporated by reference.

### BACKGROUND

The present invention relates to a method and a system for disposal of brine solution generated during a desalination process.

Desalination refers to one of several processes that remove excess salt and other minerals from an aqueous solution. Typically, water is desalinated in order to be converted to potable water suitable for human or animal consumption, or for irrigation. The choice of the desalination process depends on many factors including salinity levels of the raw water, quantities of water needed, and the form of available energy. For example, the desalination process includes, but is not limited to, reverse osmosis and electrodialysis. Regardless of the desalination process used, there is always a highly concentrated waste product comprising of the salt removed from the potable water created. Typically, the concentrated waste product is referred to as a brine solution. For example, recovery of potable water from sea water (35,000 ppm of salinity), produces a brine solution having salinity of about 70,000 ppm or above. The term salinity refers to a concentration of salt dissolved in a solution. Disposal of such brine solutions presents significant costs and challenges for the desalination industry, which results in higher cost of water. For example, the salinity of the concentrated brine solution may be above environmental standards which when disposed into the ocean may affect the inhabiting marine organisms. Environmental standards define salinity gradient which will not impact the marine organisms when a solution is disposed into the ocean. Thus, typically, ocean outfalls are used for disposing the brine solution into oceans to minimize the size of zone of discharge in which the salinity is elevated above the environmental standards.

### SUMMARY

One potential object is to reduce salinity concentration of the brine solution generated during a desalination process for disposal.

The inventors propose a method for disposing of a brine solution generated during a desalination process. The method involves providing a reverse electro-dialyzer having a plurality of concentrated compartments and a plurality of diluted compartments arranged alternately, the concentrated compartments and the diluted compartments being formed by and between successive alternately-arranged oppositely charged ion exchange membranes, the concentrated and diluted compartments and the ion exchange membranes being formed between two electrodes. The method also involves feeding the brine solution into the concentrated compartments and feeding a diluted solution into the diluted compartments, the diluted solution having a salinity lower than that of the brine solution. The method also involves allowing ions from the brine solution in the concentrated compartments to pass through the membranes to the diluted solution in the diluted compartments, thereby forming a diluted brine solution in the concentrated compartments. The method also involves extracting the diluted brine solution from the concentrated compartments for disposal. Feeding the brine solution involves controlling a first flow rate of the brine solution into the concentrated compartments and controlling a second flow rate of the diluted solution into the diluted compartments.

The inventors also propose a desalination system having a desalinator to desalinate an aqueous salt solution and produce a desalinated solution and a brine solution. The desalination system further has a reverse electro-dialyzer including a plurality of concentrated compartments and a plurality of diluted compartments, the concentrated compartments and the diluted compartments being formed by and between successive alternately-arranged oppositely charged ion exchange membranes adapted to allow passage of ions from the concentrated compartments to the diluted compartments. The reverse electro-dialyzer also has two electrodes sandwiching the concentrated and diluted compartments and the ion exchange membranes. The desalination system further has a feeder to feed the brine solution into the concentrated compartments and feed a diluted solution into the diluted compartments, the diluted solution having a salinity lower than that of the brine solution such that a diluted brine solution is formed in the concentrated compartments. The feeder includes a flow controller to control a first flow rate of the brine solution into the concentrated compartments and to control a second flow rate of the diluted solution into the diluted compartments.

The ions from the brine solution in the concentrated compartments pass through the membranes to the diluted compartments in the reverse electrodialysis process due to the difference in salinity concentration of the brine solution and the diluted solution forming a diluted brine solution in the concentrated compartments. This enables the reduction of the salinity concentration of the brine solution and the diluted brine solution may be extracted from the concentrated compartments for disposal.

According to another embodiment, the diluted solution is seawater. Seawater having a lower salinity than the brine solution may be used as the diluted solution. Moreover, as desalination plants are typically located nearby ocean or sea, availability of seawater is in abundance.

According to yet another embodiment, the method may further comprise retrieving an electrical energy produced due to the salinity difference of the brine solution and the diluted solution. The passage of ions from the concentrated compartments to the diluted compartments generates voltage and currents across the electrodes. This may be retrieved as electrical energy.

According to yet another embodiment, the electrical energy is the sum of voltages generated at each pair of the membranes. The generation of energy can be increased by increasing the number of membrane pairs.

According to yet another embodiment, the feeding of the brine solution into the concentrated compartments and the diluted solution into the diluted compartments includes controlling a first flow rate of the brine solution into the concentrated compartments and a second flow rate of the diluted solution into the diluted compartments. This enables in controlling the rate of reduction of salinity concentration of the diluted brine solution and the rate of increase of the salinity concentration of the diluted solution.

According to yet another embodiment, the first flow rate is controlled such that the salinity concentration of the diluted brine solution in the concentrated compartments is reduced below a threshold value, the threshold value is chosen such that the salinity complies with environmental standards, and the second flow rate is controlled such that the salinity of the diluted solution in the diluted compartments is maintained below the threshold value. The reduction in the salinity of the diluted brine solution below the threshold value enables in maintaining the salinity concentration of the area of the sea where the diluted brine solution is disposed to a range tolerable to the marine organisms inhabiting the area. Additionally, maintaining the salinity concentration of the diluted solution below the threshold value enables in disposing the diluted solution without affecting the marine organisms inhabiting the area of the sea where the diluted solution is disposed.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates a block diagram of a desalination system according to an embodiment herein,

FIG. 2 illustrates a reverse electrodialyzer in detail according to an embodiment herein, and

FIG. 3 illustrates a method of disposing a brine solution generated during a desalination process according to an embodiment herein.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In the following description, for purpose of explanation, numerous specific details are set forth in order to provide a thorough understanding of one or more embodiments. It may be evident that such embodiments may be practiced without these specific details.

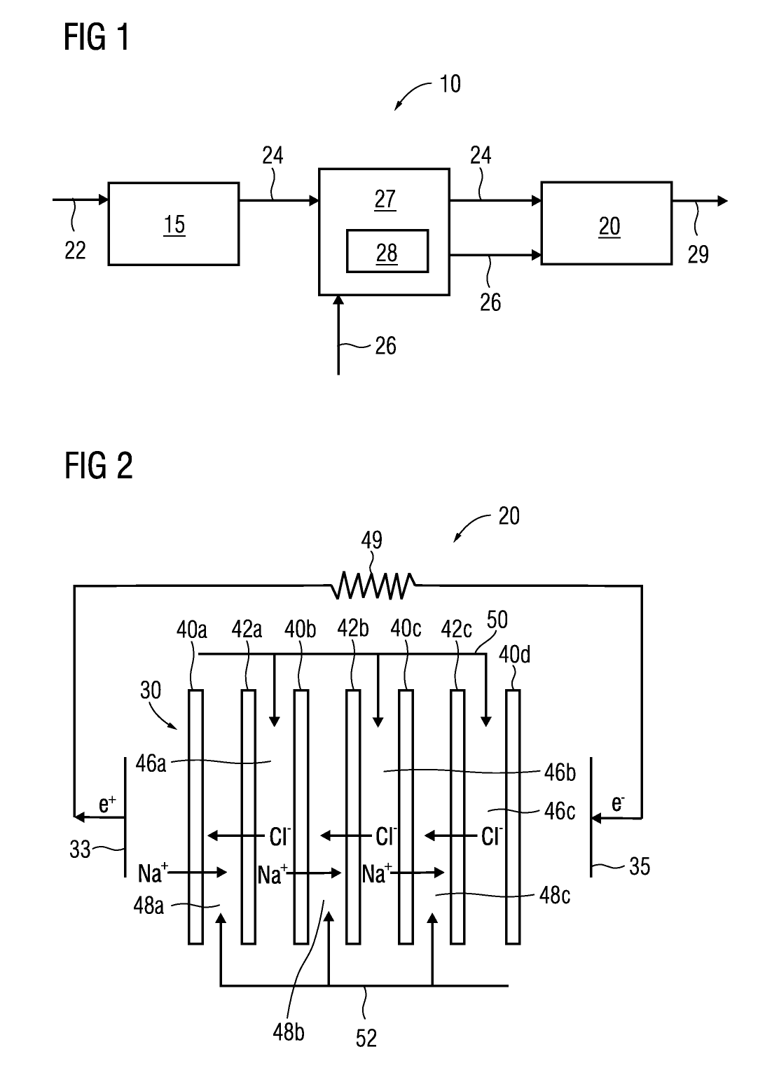

FIG. 1 illustrates a block diagram of a desalination system according to an embodiment herein. The desalination system 10 comprises a desalinator 15 and a reverse electrodialyzer 20. The aqueous solution, for example, seawater to be desalinated is fed to the desalinator 15, as shown by arrow 22. The desalinator 15 processes the aqueous solution to remove salts and other constituents so that the desalinated solution may be used, for instance, for human or animal consumption or for irrigation. For example, if the aqueous solution is seawater, the salinity of the seawater may be reduced by the desalination process. The desalinator 15 may include, but not limited to, an electrodialysis device, a reverse osmosis device, and the like.

Typically, the salts present in the aqueous solution are separated by the desalinator 15. The process of separating the slats from the aqueous solution increases the salinity concentration of the brine solution. In accordance to an embodiment, the salinity of the brine solution increased during the desalination process is reduced using a reverse electrodialysis process. The brine solution with increased salinity is fed to the reverse electrodialyzer 20 from the desalinator 15, as shown by arrow 24 as a concentrated solution. A diluted solution having a lower salinity concentration than the brine solution is also fed to the reverse electrodialyzer 20, as shown by arrow 26. Advantageously, when the aqueous solution to be desalinated using the desalinator 15 is seawater, the diluted solution to be fed to the reverse electrodialyzer 20 may also be seawater as seawater may be readily available. The salinity concentration of seawater is typically lower than the brine solution.

Referring still to FIG. 1, in an aspect, the brine solution and the diluted solution is fed into the reverse electrodialyzer 20 using a feeder 27. For example, the feeder 27 may comprise respective pumps for feeding the brine solution and the diluted solution into the reverse electrodialyzer 20. In the shown example of FIG. 1, the feeder 27 comprises a flow controller 28 to control a first flow rate of feeding the brine solution and a second flow rate of feeding the diluted solution into the reverse electrodialyzer 20. By controlling the flow rate of the brine solution and the diluted solution into the reverse electrodialyzer 20, the rate at which the salinity of the brine solution is reduced may be controlled. Flow rate of the brine solution and the diluted solution is one of the parameters on which the rate of reduction of salinity of the brine solution depends. During the reverse electrodialysis process, the salts present in the brine solution pass into the diluted solution, thus, reducing the salinity of the brine solution to form a diluted brine solution. The diluted brine solution of reduced salinity is provided as output from the reverse electrodialyzer 20, as indicated by the arrow 29.

By controlling the flow rate of feeding the brine solution and the diluted solution into the reverse electrodialyzer 20, the increase in the salinity of the diluted solution due to the reverse electrodialysis process may also be controlled. In an aspect, the salinity concentration of the diluted brine solution and the salinity concentration of the diluted solution in the reverse electrodialyzer 20 may be monitored such that the flow rate of the brine solution and the diluted solution may be controlled appropriately. In an aspect, the salinity of the diluted brine solution may be reduced below a threshold value. Advantageously, the threshold value can be chosen such that the salinity complies with environmental standards, so that marine organisms are not affected. Also, the increase in the salinity of the diluted solution may be controlled such that the salinity of the diluted solution is maintained below the threshold value. Thus, the diluted brine solution with reduced salinity and the diluted solution may be disposed without causing any harm to the environment. For example, the diluted brine solution having reduced salinity may be disposed into the ocean so that inhabiting marine organisms are not affected in the area of the ocean the solution is disposed. The diluted solution may also be disposed into the ocean, and the inhabiting marine organisms in the discharge area of the ocean may not be affected as the salinity of the same is maintained below the threshold value. Additionally, controlling the rate of flow of the brine solution and the diluted solution into the reverse electrodialyzer 20 may enable in efficient reduction of salinity of the brine solution. For example, if the brine solution and the diluted solution have the same flow rate, the salinity of the brine solution may be reduced to about 67,500 ppm. The diluted solution in this example is assumed to be seawater having a salinity of about 35,000 ppm. Typically, the salinity of the brine solution is greater than about 90,000 ppm. If the flow rate of the diluted solution is about three times the brine solution, the salinity of the brine solution may be reduced to about 51,250 ppm.

In another aspect, the outlet streams of the diluted brine solution and the diluted solution from the reverse electrodialyzer 20 may be mixed prior to disposing into the ocean to obtain a mixed solution. The outlet streams may be mixed such that the salinity of the mixed solution is maintained below the threshold. The salinity of the mixed solution may be maintained below the threshold by controlling the flow rate of feeding the brine solution and the diluted solution into the reverse electrodialyzer 20. This enables in disposing the mixed solution into the ocean so that inhabiting marine organisms are not affected in the area of the ocean the solution is disposed.

FIG. 2 with reference to FIG. 1 illustrates the reverse electrodialyzer 20 in detail according to an embodiment herein. As shown, the reverse electrodialyzer 20 includes a plurality of ion exchange membranes 30 spaced apart in a membrane stack. The reverse electrodialyzer further comprise electrodes 33, 35 at each end of the membrane stack. The electrode 33 is an anode and the electrode 35 is a cathode. The ion exchange membranes include a plurality of cation exchange membranes 40 and a plurality of anion exchange membranes 42. The cation exchange membranes 40 and the anion exchange membranes 42 are arranged alternatively to define concentrated compartments 46 and diluted compartments 48, such that each of the compartments 46, 48 have two boundary ion exchange membranes 30, one an cation exchange member 40 and the other an anion exchange member 42. The cation exchange membranes 40 are permeable to cations and exclude anions. The anion exchange membranes 42 are permeable to anions and exclude cations.

The brine solution generated during the desalination process by the desalinator 15 is fed into concentrated compartments 46a, 46b, 46c of the reverse electrodialyzer 20, as shown by arrows 50. The diluted solution is fed into the diluted compartments 48a, 48b, 48c, as shown by arrows 52. Typically, the principle of reverse electrodialysis is that solute from the concentrated solution in the concentrated compartments 46 pass to the diluted solution in the diluted compartments 48 through the ion exchange membranes 30. Thus, ions present in the brine solution pass into the diluted compartments 48 from the concentrated compartments 46.

Referring still to FIG. 2, in an aspect, anions from the concentrated compartment 46a shall pass through the anion exchange membrane 42a to move to the diluted compartment 48a. Thus, chloride ions (CO being negatively charged shall pass from the concentrated compartment 46a to the diluted compartment 48a through the anion exchange membrane 42a. The anion exchange membrane 42a being permeable to anions and excluding cations permit the chloride ions to pass though as chloride ions are negatively charged. Similarly, chloride ions from the concentrated compartment 46b shall pass through the anion exchange membrane 42b to move to the diluted compartment 48b and the chloride ions from the concentrated compartment 46c shall pass though the anion exchange membrane 42c to move to the diluted compartment 48c.

The sodium ions (Na⁺) from the concentrated compartment 46a shall pass through the cation exchange membrane 40b to move to the diluted compartment 48b. The cation exchange membrane 40b being permeable to cations and excluding anions permit the sodium ions to pass though. Similarly, the sodium ions from the concentrated compartment 46b shall pass through the cation exchange membrane 40c to move to the diluted compartment 48c. In the present example, a diluted compartment is not shown successive to the concentrated compartment 46c in the direction of the electrode 35. In case a diluted compartment is present, the sodium ions from the concentrated compartment 46c shall pass through the cation exchange membrane 40d to move to the diluted compartment. The passage of ions from the brine solution in the concentrated compartments 46 to the diluted compartments 48 forms a diluted brine solution in the concentrated compartments 46. Thus, the salinity of the brine solution in the concentrated compartments 46 is reduced by the passage of the ions to the diluted solution.

Still referring to FIG. 2, in an aspect, the passage of ions from the concentrated compartments 46 to the diluted compartments 48 generates electrical voltage and electrical current across the electrodes 33, 35. When an external resistance 49 is connected across the electrodes 33, 35, current will flow and an electrical energy may be obtained.

Typically, the electrical energy generated across the electrodes 33, 35 is related to the salinity of the brine solution and the diluted solution. The open circuit voltage (V⁰) per pair of membranes 30 of the reverse electrodialyzer 20 may be derived as:

$${V}^{0} = \frac{2 {α}_{av} RT}{zF} ln \frac{{a}_{c}}{{a}_{d}} volt \qquad ( 1 )$$

Where,
V⁰ is open circuit voltage of a pair of membranes in volt,
αₐᵥ is average membrane permselectivity of anions and cation membranes,
R is gas constant, 8.314 J/(mol K),
T is absolute temperature in K,
z is electrochemical valence,
F is Faraday constant, 96485 C/mol,
a_{c} is activity of concentrated solution in mol/L, and
a_{d} is activity of diluted solution in mol/L

The maximum eletrical power out may be derived as:

$${W}_{max} = \frac{( {NV}^{0} )}{4 \frac{N}{A} ( {R}_{aem} + {R}_{cem} + \frac{{d}_{c}}{{k}_{c}} + \frac{{d}_{d}}{{k}_{d}} )} watt \qquad ( 2 )$$

Where,
Wₘₐₓ is maximum electrical power output in watt,
N is number of pairs of membranes,
A is effective membrane area in m²,
Rₐₑₘ is area resistance of anion exchange membrane in ohm·m²,
R_{cem} is area resistance of cation exchange membrane in ohm·m²,
d_{c} is thickness of concentrated compartment in m,
d_{d} is thickness of diluted compartment in m,
k_{c} is conductivity of concentrated compartment in S/m, and
k_{d} is is conductivity of diluted compartment in S/m.

Thus, electrical power may also be generated in the process of reverse electrodialysis while reducing the salinity of the brine solution. The output electrical power may be increased by increasing the number of pairs of the membranes 30 as the electrical power generated is the sum of voltages generated at each pair of the membranes 30.

### EXAMPLE

In the present example, assuming the brine solution to have the total dissolved solids of 100,000 ppm, and the diluted solution to have the total dissolved solids of 35,000 ppm, the open circuit voltage (V⁰) of a pair of membranes is:

$${V}^{0} = \frac{2 {α}_{av} RT}{zF} ln \frac{{a}_{c}}{{a}_{d}} \approx \frac{2 \cdot 8.314 \cdot 298}{96500} ln \frac{100000}{35000} \approx 0.051$$

Thus, the open circuit voltage (V⁰) per pair of membranes is 51 mV. For a reverse electrodialyzer with 500 pairs of membranes, the open circuit voltage (V⁰) is 25.5 Volts.

The maximum electrical power output of a reverse electrodialyzer with 500 pairs of membranes is:

$$\begin{matrix}{W}_{max} = \frac{( {NV}^{0} )}{4 \frac{N}{A} ( {R}_{aem} + {R}_{cem} + \frac{{d}_{c}}{{k}_{c}} + \frac{{d}_{d}}{{k}_{d}} )} \\ = \frac{{( 500 \cdot 0.051 )}^{2}}{4 \frac{500}{50 \cdot 100} ( 0.6 + 0.6 + \frac{0.015}{0.126} + \frac{0.015}{0.054} )} \\ \approx 40 watt\end{matrix}$$

In the present example, the Rₐₑₘ and R_{cem} have been assumed as 0.6 ohm m², the d_{c} and d_{c} have been assumed as 150 μm, and A is assumed as 50 cm by 100 cm.

Based on thermodynamic calculations, when mixing 1 m³ of brine solution with 100,000 ppm of total dissolved solids and 1 m³ of seawater with 35,000 ppm of total dissolved solids, the Gibbs energy is about 0.38 kWh. Thus, electrical energy of about 0.38 kWh may be obtained per m³ of brine solution in an ideal situation.

Thus, electrical power may also be generated in the process of reverse electrodialysis while reducing the salinity concentration of the brine solution.

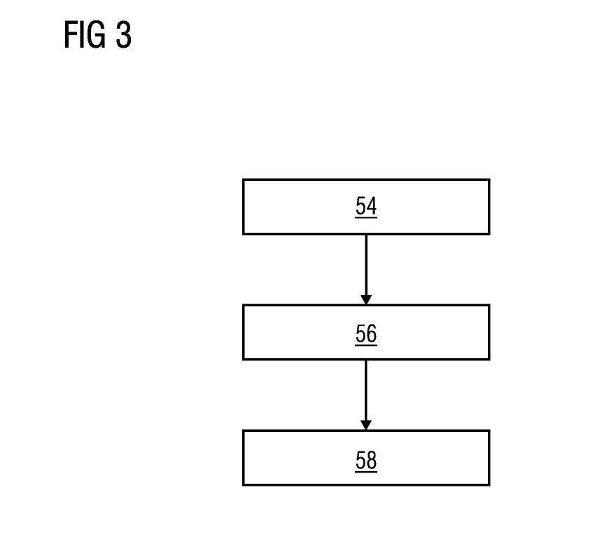

FIG. 3 with reference to FIG. 1 and FIG. 2 illustrates a method of disposing a brine solution generated during a desalination process according to an embodiment herein. At block 54, a reverse electrodialyzer 20 comprising a plurality of concentrated compartments 46 and diluted compartments 48 arranged alternatively, the concentrated compartments 46 and the diluted compartments 48 being formed by successive alternatively arranged oppositely charged ion exchange membranes 30 between two electrodes 33, 35 is provided. Next at block 56, the brine solution is fed to the concentrated compartments 46 and a diluted solution is fed to the diluted compartments 48, the salinity of the diluted solution being lower than the salinity of the brine solution, whereby ions from the brine solution in the concentrated compartments 46 pass through the membranes 30 to the diluted solution in the diluted compartments 48. Next, at block 58, the brine solution is extracted from the concentrated compartments 46 for disposal.

The embodiments described herein enable in reducing the salinity of the brine solution generated during a desalination process. The reduction of the salinity of the brine solution enables is disposing the diluted brine solution without impacting the environment. For example, the diluted brine solution with reduced salinity may be discharged into the sea. Moreover, as the salinity of the diluted solution is maintained below the threshold value, the diluted solution may also be discharged without impacting the environment. For example, the diluted brine solution with reduced salinity may be disposed into the ocean as the same may not affect the inhibiting marine organisms in the area of the ocean the brine solution is disposed.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for disposing of a brine solution generated during a desalination process, the method comprising:
providing a reverse electro-dialyzer comprising a plurality of concentrated compartments and a plurality of diluted compartments arranged alternately, the concentrated compartments and the diluted compartments being formed by and between successive alternately-arranged oppositely charged ion exchange membranes, the concentrated and diluted compartments and the ion exchange membranes being formed between two electrodes;
feeding the brine solution into the concentrated compartments;
feeding a diluted solution into the diluted compartments, the diluted solution having a salinity lower than that of the brine solution;
allowing ions from the brine solution in the concentrated compartments to pass through the membranes to the diluted solution in the diluted compartments, thereby forming a diluted brine solution in the concentrated compartments; and
extracting the diluted brine solution from the concentrated compartments for disposal, wherein
feeding the brine solution comprises controlling a first flow rate of the brine solution into the concentrated compartments, and
feeding the diluted solution comprises controlling a second flow rate of the diluted solution into the diluted compartments.

14. The method according to claim 13, wherein the diluted solution is seawater.

15. The method according to claim 13, further comprising retrieving electrical energy produced by a salinity difference of the brine solution from the diluted solution.

16. The method according to claim 13, wherein the electrical energy is retrieved from the electrodes.

17. The method according to claim 15, wherein the electrical energy has a voltage equivalent to a sum of voltages generated at each pair of the membranes.

18. The method according to claim 13, wherein
the first flow rate is controlled such that the diluted brine solution produced in the concentrated compartments has a salinity reduced below a threshold value, the threshold value being chosen such that the salinity complies with environmental standards, and
the second flow rate is controlled such that diluted solution exiting the diluted compartments has a salinity maintained below the threshold value.

19. The method according to claim 13, further comprising:
determining the salinity of the brine solution;
determining the salinity of the diluted solution;
identifying an environmental maximum salinity; and
controlling the first and second flow rates such that a combined salinity of the brine and diluted solutions is below the environmental maximum salinity.

20. The method according to claim 14, further comprising retrieving electrical energy produced by a salinity difference of the brine solution from the diluted solution.

21. The method according to claim 20, wherein the electrical energy is retrieved from the electrodes.

22. The method according to claim 21, wherein the electrical energy has a voltage equivalent to a sum of voltages generated at each pair of the membranes.

23. The method according to claim 22, wherein
the first flow rate is controlled such that the diluted brine solution produced in the concentrated compartments has a salinity reduced below a threshold value, the threshold value being chosen such that the salinity complies with environmental standards, and
the second flow rate is controlled such that diluted solution exiting the diluted compartments has a salinity maintained below the threshold value.

24. A desalination system, comprising:
a desalinator to desalinate an aqueous salt solution and produce a desalinated solution and a brine solution;
a reverse electro-dialyzer comprising:
a plurality of concentrated compartments and a plurality of diluted compartments, the concentrated compartments and the diluted compartments being formed by and between successive alternately-arranged oppositely charged ion exchange membranes adapted to allow passage of ions from the concentrated compartments to the diluted compartments;
two electrodes sandwiching the concentrated and diluted compartments and the ion exchange membranes; and
a feeder to feed the brine solution into the concentrated compartments and feed a diluted solution into the diluted compartments, the diluted solution having a salinity lower than that of the brine solution such that a diluted brine solution is formed in the concentrated compartments, wherein
the feeder includes a flow controller to control a first flow rate of the brine solution into the concentrated compartments and to control a second flow rate of the diluted solution into the diluted compartments.

25. The system according to claim 24, wherein the diluted solution is seawater.

26. The system according to claim 24, further comprising connections to the two electrodes to retrieve electrical energy produced by a salinity difference of the brine solution from the diluted solution.

27. The system according to claim 26, wherein the electrical energy has a voltage equivalent to a sum of voltages generated at each pair of the membranes.

28. The system according to claim 24, wherein
the flow controller controls the first flow rate such that the the diluted brine solution formed in the concentrated compartments has a salinity reduced below a threshold value, the threshold value being chosen such that the salinity complies with environmental standards, and
the flow controller controls the second flow rate such that the diluted solution exiting the diluted compartments has a salinity maintained below the threshold value.

29. The system according to claim 25, further comprising connections to the two electrodes to retrieve electrical energy produced by a salinity difference of the brine solution from the diluted solution.

30. The system according to claim 29, wherein the electrical energy has a voltage equivalent to a sum of voltages generated at each pair of the membranes.

31. The system according to claim 30, wherein
the flow controller controls the first flow rate such that the the diluted brine solution formed in the concentrated compartments has a salinity reduced below a threshold value, the threshold value being chosen such that the salinity complies with environmental standards, and
the flow controller controls the second flow rate such that the diluted solution exiting the diluted compartments has a salinity maintained below the threshold value.
